(19) United States
(12) Patent Application Publication
(10) Pub. No.: US 2008/0067709 A1
(43) Pub. Date: Mar. 20, 2008

(54) Expandable Polystyrene Composition and Process for Making Same

(76) Inventors: Jean-Marc Galewski, Noeux-les-Mines (FR); Gordon Dawkins, Festubert (FR); Karine Labastie Coeyrehourcq, Lille (FR)

Correspondence Address: NIXON & VANDERHYE, PC, 901 NORTH GLEBE ROAD, 11TH FLOOR, ARLINGTON, VA, 22203, US

(21) Appl. No.: 11/632,375

(22) PCT Filed: Jun. 30, 2005
(86) PCT No.: PCT/GB05/02563

§ 371 Date: Jan. 12, 2007

(30) Foreign Application Priority Data
Jul. 13, 2004 (FR) 0407778

(51) Int. Cl. C08J 9/20; C01B 33/44; C08K 9/04

(52) U.S. Cl. 264/53; 521/60

(57) ABSTRACT

An expandable polystyrene composition in the form of beads is disclosed, comprising: (1) 100 parts by weight of a styrene polymer having in particular a weight-average molecular weight Mw ranging from 150 000 to 400 000 daltons, (2) from 3 to 20 parts by weight of a blowing agent, which is water or a mixture of water with at least one other blowing agent for example a hydrocarbon (3) from 0.1 to 12 parts by weight of at least one modified clay with an at least partially lipophilic nature. Also disclosed is a process for making the compositions.

The present invention relates to an expandable polystyrene composition in the form of beads, to a process of preparation and to the use of the composition in the manufacture of moulded and expanded objects.

It is known to manufacture objects made of polystyrene foam, also known as XPS (expanded polystyrene), by addition of a blowing agent directly to a polystyrene in the molten state in an extruder, so as to form a homogeneous blend which is subsequently extruded using a die in the form of a slab or of a sheet and which is thus subjected to expansion and to cooling in the surrounding air. Generally, objects made of XPS are not moulded and have a skin on the outside. They have a relatively high bulk density which can be greater than 30 kg/m³ and less than 100 kg/m³ and can range in particular from 32 to 60 kg/m³. They exhibit a generally anisotropic cellular structure and are used in specific building insulation applications, such as floors and roofs.

It is also known to manufacture expanded and moulded objects from beads made of expandable polystyrene, also known as EPS (expandable polystyrene), in which a blowing agent has been incorporated. The EPS beads are generally prepared by polymerization of the styrene in the presence of a blowing agent introduced at the beginning, during and/or at the end of polymerization. The process for the manufacture of the expanded and moulded objects subsequently comprises usually three stages:
(a) a stage of preexpanding (or prefoaming) the EPS beads by mixing the latter with steam, so as to develop the desired cellular structure and achieve a relatively low bulk density, in particular equal to or less than 50 kg/m³, preferably less than or equal to 30 kg/m³, for example ranging from 10 to 25 kg/m³,
(b) a stage of stabilizing (or maturing) the expanded beads by storing the latter (or leaving them standing) in the open air for a period of time ranging from a few hours to a few days, and
(c) a stage of moulding the expanded and stabilized beads by heating the latter in a mould, so as to weld the beads together and to maintain, within each bead, the cellular structure with the bulk density desired, generally close to that obtained during the preexpanding stage.

The expanded and moulded objects manufactured from EPS beads generally have a relatively low bulk density ranging from 10 to 50 kg/m³, often less than that of the objects made of XPS, and which can range from 10 to 30 kg/m³. They exhibit a structure composed of beads welded together, each bead having a cellular structure of generally isotropic type. They are used in specific building insulation applications, such as walls, or alternatively in specific packaging applications for industrial or food products, due to the specific forms given by the mould.

Furthermore, it is known to be able to improve certain polymer properties, such as the tensile modulus, the flame retardancy and the thermal insulation, in particular in the case of polystyrene and of polystyrene foam of XPS type. This improvement can be obtained by adding clays to the polymer, so as to form materials known as “nanocomposite polymers”. Natural clays or clays modified so as to render them compatible with the polymers have been used to manufacture polystyrene foams of XPS type, either by mechanically blending a clay with a molten polystyrene mixed with a blowing agent, such as carbon dioxide, or by bulk polymerization of the styrene in the presence of a clay and subsequently by addition of a blowing agent, such as carbon dioxide, to the mass of molten polymer.

A need has appeared to develop expandable polystyrene beads comprising clays and also a process which allows them to be prepared with the use of water as the blowing agent. One of the major problems is to develop an expandable polystyrene composition in the form of beads comprising clays with water as the blowing agent. In such a composition, the clays can exist in a more or less advantageous form, for example with an “intercalated” or alternatively “exfoliated” structure, in which the polystyrene can be incorporated in a more or less intimate and deep-seated way. Expanded and moulded objects having a highly variable and random compromise in properties can result from this degree of incorporation. In addition, this objective is rendered particularly difficult owing to the fact that the expandable polystyrene beads are generally prepared by polymerization of the styrene in aqueous suspension and that a blowing agent is introduced during this preparation. Such a preparation thus simultaneously employs an organic phase and an aqueous phase, with very different natures and viscosities. It then becomes particularly difficult to predict how the clay used in this preparation can be simultaneously compatible or incompatible with the styrene (the monomer), the polystyrene, the blowing agent and the water of the aqueous suspension and how it can in addition optionally act as nucleating and/or suspending agent. One of the major risks in an aqueous suspension polymerization is the phenomenon referred to as “loss of suspension”, during which the beads of monomer and of polymer being formed undergo coalescence and suddenly set solid. Another major risk is the stage of preexpanding the beads carried out with steam, during which water can interact with the clay present in the beads and can seriously disrupt this stage.

Finally, it is known to manufacture expandable polystyrene beads comprising, as blowing agent, solely one or more hydrocarbons, such as alkanes. A problem has appeared as a result of the emission in the atmosphere of these hydrocarbons and a need has made itself felt to at least partially replace these hydrocarbons by other blowing agents which are less polluting for example water.

The present invention comprises an expandable polystyrene composition in the form of beads, comprising:
(1) 100 parts by weight of a styrene polymer having in particular a weight-average molecular weight Mw ranging from 150 000 to 400 000 daltons,
(2) from 3 to 20 parts by weight of a blowing agent, which is water or a mixture of water with at least one other blowing agent for example a hydrocarbon
(3) from 0.1 to 12 parts by weight of at least one modified clay with an at least partially lipophilic nature

The present invention further comprises an expandable polystyrene composition in the form of beads, comprising:
(1) 100 parts by weight of a styrene polymer having in particular a weight-average molecular weight Mw ranging from 150 000 to 400 000 daltons,
(2) from 3 to 20 parts by weight of at least one blowing agent, preferably at least two blowing agents, one being water and the other being at least one hydrocarbon blowing agent, in particular in a water/hydrocarbon blowing agent(s) ratio by weight ranging from 0.1/1 to 10/1, and
(3) from 0.1 to 12 parts by weight of at least one modified clay with an at least partially lipophilic nature.

The composition is provided in the form of beads and comprises a styrene polymer said to be “expandable” in that the polymer comprises a blowing agent and that the beads are capable of expansion without the aid of an additional amount of blowing agent.

The term “beads” is understood to mean generally spherical or substantially spherical particles, in particular spheroidal particles, which can exhibit a large diameter and a small diameter and for which the ratio between the large diameter and the small diameter can range from 1.0 to 1.3, preferably from 1.0 to 1.2, in particular from 1.0 to 1.1. The expandable beads can have a mean size ranging from 0.3 to 3.0 mm, preferably from 0.3 to 2.0 mm, in particular from 0.4 to 1.5 mm. They can have a bulk density ranging from 560 to 720 kg/m³, preferably from 580 to 710 kg/m³, in particular from 600 to 700 kg/m³.

The composition comprises a styrene polymer which can be a homopolystyrene or a copolymer of styrene comprising at least 50%, preferably at least 80%, in particular at least 90%, by weight of styrene. The comonomer or comonomers present in the styrene copolymer can be chosen from vinylaromatic compounds, such as α-methylstyrene, a styrene halogenated in the aromatic ring or a styrene alkylated in the aromatic ring. It is preferable to use a homopolystyrene. The weight-average molecular weight Mw of the styrene polymer can be chosen within a range from 150 000 to 400 000 daltons, preferably from 170 000 to 300 000 daltons, in particular from 175 000 to 280 000 daltons. The distribution in the molecular weight of the styrene polymer, calculated by the ratio of Mw to the number-average molecular weight Mn of the polymer, can range from 1.5 to 3.5, preferably from 1.7 to 3.0, in particular from 1.8 to 2.8. The styrene polymer can have a relatively low content of residual monomer and optionally of residual comonomer(s), for example less than 2000 parts by weight per million (ppm), preferably less than 1000 ppm, in particular less than 800 ppm, especially less than 500 ppm.

The composition comprises, per 100 parts by weight of styrene polymer, from 3 to 20 parts, preferably from 4 to 18 parts, in particular from 4 to 16 parts, by weight of a blowing agent which is water or a mixture of water with at least one other blowing agent, in particular a hydrocarbon blowing agent, preferably chosen from saturated hydrocarbons, in particular from saturated linear or branched hydrocarbons and saturated cyclic hydrocarbons, especially from saturated C₃ to C₇, more particularly C₄ to C₆, hydrocarbons. Thus, the hydrocarbon blowing agent can be a saturated hydrocarbon or a mixture of two or more saturated hydrocarbons chosen in particular from n-butane, isobutane, n-pentane, isopentane, n-hexane, isohexane, n-heptane and isoheptane, preferably a mixture of n-pentane and of isopentane.

The composition comprises water as a blowing agent. When water is the sole blowing agent it comprises (per 100 parts by weight of a styrene polymer) from 3 to 20 parts by weight of the composition. When there is one or more other blowing agent in addition to water, the composition may comprise (per 100 parts by weight of a styrene polymer) 0.1 to 19, preferably 0.5 to 15, for example 1 to 10 parts by weight of the composition.

The composition can preferably comprise at least two blowing agents, one being water and the other being at least one hydrocarbon blowing agent, in particular a saturated hydrocarbon or a mixture of two or more saturated hydrocarbons, such as those mentioned above, in particular in a water/hydrocarbon blowing agent(s) ratio by weight ranging from 0.1/1 to 10/1, preferably from 0.2/1 to 9/1, in particular from 0.5/1 to 8/1, more particularly from 1/1 to 7/1.

The composition also comprises, per 100 parts by weight of styrene polymer, from 0.1 to 12 parts, preferably from 0.2 to 10 parts, in particular from 0.3 to 8 parts, by weight of at least one modified clay with an at least partially lipophilic nature. The term “clay” is well known in the field of nanocomposites and generally relates to materials which are based on silicate, which have in particular a lamellar (or multilayer) structure and which are capable of exchanging interstitial inorganic cations, in particular alkali metal or alkaline-earth metal cations, such as Li⁺, Na⁺, K⁺, Ca²⁺ or Mg²⁺. A clay with an exchangeable interstitial cation exhibits the advantage of being able to be modified: it can in particular exhibit an interstitial distance between the lamellae (or layers) which can be modified and in particular increased. It is thus possible to choose as desired a modified clay with an expanded lamellar structure or “intercalated” structure or alternatively with an “exfoliated” structure, as described subsequently. Such a clay is often referred to as a “cationic clay”: it is generally an aluminium silicate (or aluminosilicate) with a lamellar (or layered) structure. The silicate is in particular negatively charged and comprises exchangeable interstitial inorganic cations, in particular alkali metal or alkaline-earth metal cations, such as those mentioned above. These exchangeable cations are generally positioned in the interstitial (or interlayer) spaces and counterbalance the negative charge of the clay. Thus, the clay can be a cationic clay which, before modification, has in particular exchangeable interstitial inorganic cations and exhibits in particular an expandable lamellar structure.

More particularly, the clay can be chosen from phyllosilicates or lamellar (or layered) silicates, optionally in the fibrous form. The clay can be a cationic clay chosen in particular from smectite, an illite, a chlorite and a hormite. Preferably, the clay is a smectite, chosen in particular from a montmorillonite, a nontronite, a beidellite, a hectorite, a laponite, a volkonskoite, a saponite, a sauconite and a vermiculite. The clay can be an illite which forms part of the family of the micas, among which a ledikite can be chosen. However, illite is a clay which is not so suitable in the present composition as it has little in the way of exchangeable cations and has a lamellar structure which is not very expandable, and it is therefore difficult to modify. The clay can be a chlorite, which is a mixed clay of the family of the micas and brucites. The clay can also be a hormite, chosen in particular from an attapulgite (or palygorskite) and a sepiolite. The clay can also be a lamellar (or layered) silicate chosen in particular from a magadiite, a kenyaite, a fluotomica and a fluorohectorite. The clay can also be a lamellar (or layered) silicate in the fibrous form chosen in particular from an attapulgite (or palygorskite), a boehmite, an imogolite and a sepiolite. According to the invention, the clay is preferably a smectite, chosen in particular from a montmorillonite, a nontronite, a beidellite, a hectorite, a saponite and a sauconite, or a lamellar (or layered) silicate, chosen in particular from a magadiite, a kenyaite, a fluoromica and a fluorohectorite. Preference is more particularly given, as clay, to a montmorillonite or a bentonite which comprises a montmorillonite as essential component.

It is known that (natural or synthetic) clays are naturally hydrophilic. However, the expandable polystyrene composition according to the invention comprises a modified clay with an at least partially lipophilic (or “organophilic”) nature, in particular with an amphiphilic nature, that is to say having a partially hydrophilic and partially lipophilic nature. The modified clay can also have a substantially or completely lipophilic nature, in particular no longer having an obvious hydrophilic nature. More particularly, the composition comprises a clay, such as one of those mentioned above, in particular a cationic clay, which is modified by ion exchange using an organic cation, in particular of an organic cationic surfactant. Thus, the modification of the clay can consist in particular of a treatment by ion exchange (also known under the term of “lipophilization”). This treatment is carried out in particular by exchange of an interstitial inorganic cation of the clay with an organic cation, in particular using one derived from an organic cationic surfactant.

The modified clay preferably comprises at least one organic cation chosen in particular from organic onium, phosphonium or sulphonium cations having in particular at least one alkyl, aryl, aralkyl or acyl radical, preferably at least one aralkyl radical. The organic onium, phosphonium or sulphonium cations can be cations derived respectively from organic amines, phosphines or sulphides which are in particular alkylated, arylated, aralkylated or acylated, preferably aralkylated. The modified clay preferably comprises at least one onium cation chosen in particular from primary, secondary, tertiary or, preferably, quaternary organic ammonium cations and more particularly from quaternary ammonium cations having in particular four radicals chosen especially from alkyl, aryl, aralkyl and/or acyl radicals and preferably having at least one aralkyl radical, such as the benzyl radical. In the lipophilization treatment, the organic cation and in particular the quaternary ammonium cation can advantageously have an organic radical itself having a carbon-carbon double bond, in particular a terminal carbon-carbon double bond, and being in particular capable of reacting (or of (co)polymerizing) with the styrene so as to form, on contact with the styrene, a macromolecular styrene chain attached (or grafted) to the organic part of the cation. Thus, the modified clay can comprise an organic cation having an organic radical to which is attached (or grafted) a styrene polymer which is in particular different in nature from or, preferably, identical in nature to the polymer of the composition.

More particularly, the modified clay can comprise a quaternary ammonium cation corresponding to the general formula:
(R₁R₂R₃R₄)N⁺ (1)
in which R₁, R₂, R₃ and R₄, which are identical or different, represent organic radicals chosen in particular from alkyl, cycloalkyl, aryl, aralkyl or acyl radicals, preferably aralkyl radicals, one of these radicals optionally being substituted with a polar group, such as a carboxylic ester group or an ether group, and/or attached (or grafted) to a styrene polymer which is different in nature from or, preferably, identical in nature to the polymer of the composition. More particularly, the organic radicals R₁, R₂, R₃ and R₄ can be chosen from:
saturated, linear or branched, preferably C₁ to C₂₄, alkyl radicals, in particular C₁ to C₅ radicals, such as the methyl or ethyl radicals, and/or C₆ to C₂₀, especially C₈ to C₁₈, radicals, such as the n-octyl, 2-ethylhexyl, n-decyl, n-dodecyl, n-tetradecyl, n-hexadecyl or n-octadecyl (or stearyl) radicals, or C₁₆ to C₁₈ alkyl radicals, such as hydrogenated tallow alkyl radicals,
aryl radicals, preferably C₆ to C₁₄ radicals, in particular C₆ to C₁₀ radicals, such as the phenyl radical (C₆H₅—),
aralkyl radicals, in particular C₇ to C₁₄ radicals, such as the benzyl (C₆H₅—CH₂—) or phenethyl (C₆H₅—CH₂—CH₂—) radicals, optionally substituted on the ring by at least one other alkyl radical itself optionally attached (or grafted) to a styrene polymer which is different in nature from or, preferably, identical in nature to the polymer of the composition,
linear or branched, preferably C₂ to C₂₄, preferably C₈ to C₂₀, acyl radicals, such as the acetyl radical.

It is preferable to choose a quaternary ammonium cation having at least one aralkyl radical, in particular the benzyl radical. A clay modified by such a quaternary ammonium cation generally exhibits the advantage of improving the insertion of the styrene polymer and/or of the blowing agent, in particular hydrocarbon blowing agent, into the lamellar structure of the clay and of thus making possible expansion of the lamellar structure until an “exfoliated” structure, as described subsequently, in particular is achieved.

The organic cation present in the modified clay can, for example, be chosen from tetramethylammonium, tetraethylammonium, trioctylmethylammonium, stearyltrimethylammonium, distearyldimethylammonium, stearyldimethylbenzylammonium, stearyldimethylphenylethylammonium, dodecyltrimethylammonium, didodecyldimethylammonium, dodecyldimethylbenzylammonium, dodecyldimethylphenylethylammonium, tetradecyltrimethylammonium, ditetradecyldimethylammonium, tetradecyldimethylbenzylammonium, tetradecyldimethylphenylethylammonium, hexadecyltrimethylammonium, dihexadecyldimethylammonium, hexadecyldimethylbenzylammonium, hexadecyldimethylphenylethylammonium, octadecyltrimethylammonium, dioctadecyldimethylammonium, octadecyldimethylbenzylammonium, octadecyldimethylphenylethylammonium, dimethyldi(hydrogenated tallow alkyl)ammonium, dimethyl(hydrogenated tallow alkyl)(2-ethylhexyl)ammonium, benzyldimethyl(hydrogenated tallow alkyl)ammonium, methylbenzyldi(hydrogenated tallow alkyl)ammonium, vinylbenzyltrimethylammonium, to which a styrene polymer is grafted via the double bond of the vinylbenzyl radical, vinylbenzyldimethyldodecylammonium, to which a styrene polymer is grafted via the double bond of the vinylbenzyl radical, and methacryloyloxy(2-ethylhexadecyl)dimethylammonium, to which a styrene polymer is grafted via the double bond of the methacryloyloxy radical.

The modified clay is generally present in the state uniformly dispersed in the expandable polystyrene composition. In addition, it can be provided in various forms, according to whether the lamellar structure of the modified clay is more or less substantially modified by the insertion of the styrene polymer and of the blowing agent, into the interstitial spaces of the clay. Thus, in a first alternative form, the modified clay can be present in the expandable polystyrene composition in the form of aggregates of crystallites with a lamellar structure which is unchanged with respect to that of the modified clay. More particularly, it can be provided in the form of a phase separate from the styrene polymer and from the blowing agent, in particular a form according to which the lamellar structure of the modified clay is not affected either by the styrene polymer or by the blowing agent. For this reason, it can exhibit at least one X-ray diffraction peak which is unchanged and which corresponds to the interstitial distance of the lamellar structure of the modified clay.

According to a preferred alternative form, the modified clay can be present in the expandable polystyrene composition in the form of an “intercalated” (or “intercalation”) lamellar structure. The intercalated lamellar structure results in particular from the insertion of the chains of the styrene polymer and/or of the blowing agent into the interstitial spaces (or between the lamellae) of the clay and corresponds in particular to an expanded lamellar structure. The modified clay with an intercalated lamellar structure can generally exhibit at least one X-ray diffraction peak characteristic of an expanded lamellar structure and corresponding in particular to an interstitial distance substantially widened by the insertion of the chains of the styrene polymer and/or of the blowing agent.

According to another preferred alternative form, the modified clay can be present in the expandable polystyrene composition in the form of an “exfoliated” (or “exfoliation”) structure, in particular formed by exfoliation of the lamellar structure of the clay. In this case, the exfoliation results from the extensive penetration of the chains of the styrene polymer and/or of the blowing agent into the lamellar structure of the clay, resulting in particular in delamination or especially the destruction of the lamellar structure of the modified clay. Thus, the modified clay with an exfoliated structure generally does not exhibit any X-ray diffraction peak. It can advantageously form an intimate mixture, in particular an undifferentiated mixture, with the styrene polymer and the blowing agent in which the clay no longer exhibits a lamellar structure.

In the expandable polystyrene composition, the modified clay exhibits an at least partially lipophilic nature or, preferably, a substantially lipophilic nature. The term “substantially lipophilic” is understood to mean generally a modified clay in which at least 50%, preferably at least 80%, in particular at least 90%, especially at least 95%, of the exchangeable inorganic cations (measured according to the standard method “NF X31-130” which determines the cation exchange capacity (CEC) of the clay) are effectively exchanged by an organic cation, as described above. Generally, the CEC depends both on the nature and on the mean size of the particles of the clay. Thus, as examples, a sodium montmorillonite can have, depending on the mean size of the particles, a CEC ranging from 90 to 120 milliequivalents per 100 g and a calcium montmorillonite can have a CEC ranging from 70 to 100 milliequivalents per 100 g.

Methods for the preparation of a modified clay with an at least partially lipophilic nature are known and described, for example, by Guodong Liang et al. in “Journal of Applied Polymer Science”, Vol. 91, pages 3974 to 3980 (2004). Modified clays with an at least partially lipophilic nature are available commercially and are sold by Southern Clay Products Inc., CO-OP Chemical Company Ltd, Elementis Specialities or Süd-Chemie AG.

Another subject-matter of the present invention is a process for the preparation of the expandable polystyrene composition in the form of beads, as is described above, comprising a polymerization of styrene and optionally of at least one comonomer, as mentioned above, carried out in aqueous suspension and with stirring, by bringing 100 parts by weight of styrene and optionally of the comonomer or comonomers into contact with at least one radical polymerization initiator and at least one suspending agent, which process is characterized in that the contacting operation is carried out in addition in the presence (a) of 4 to 23 parts by weight of a blowing agent which is water or a mixture of water and at least one other blowing agent for example a hydrocarbon blowing agent, and (b) of 0.1 to 12 parts by weight of at least one modified clay with an at least partially lipophilic nature.

The aqueous suspension polymerization can be carried out at a temperature chosen within a range from 80 to 150° C., preferably from 85 to 140° C. It can be carried out with a ratio by weight of the water to the styrene and optionally the comonomer or comonomers which can range from 0.2/1 to 5/1, preferably from 0.5/1 to 4/1. The polymerization can be continued for a period of time such that the residual content of monomer and optionally of comonomer(s) is less than 2000 ppm, preferably less than 1000 ppm, in particular less than 800 ppm and especially less than 500 ppm. The expandable polystyrene composition in the form of beads is thus obtained directly by separating in particular the beads from the aqueous phase of the suspension. The beads can be subsequently dried, sieved and/or coated with adjuvants, such as antistatic agents or plasticizers, for example mono-, di- or triglycerol stearates or zinc stearate.

The polymerization is carried out in particular by bringing the styrene and optionally the comonomer or comonomers into contact with one or more radical polymerization initiators, that is to say initiators of free radicals, preferably chosen from peroxides, hydroperoxides, peroxycarbonates, perketals, peresters and azo compounds. The amount of radical initiator(s) can be from 0.01 to 1 part, preferably from 0.05 to 0.8 part, by weight per 100 parts by weight of styrene and optionally of comonomer or comonomers. The initiators can be chosen from peroxides, such as dibenzoyl peroxide, dicumyl peroxide or di(tert-butyl) peroxide, from peroxycarbonates, such as tert-butylperoxy 2-ethylhexyl carbonate, tert-amylperoxy 2-ethylhexyl carbonate, tert-amylperoxy isopropyl carbonate or tert-butylperoxy stearyl carbonate, from perketals, such as 2,2-bis(tert-butylperoxy)butane or 1,1-bis(tert-butylperoxy)cyclohexane, from peresters, such as tert-butyl perbenzoate, or from azo compounds, such as 2,2′-azo-bisisobutyronitrile. They can be introduced entirely at the beginning of polymerization or else a portion at the beginning and the remaining portion during the polymerization.

The polymerization is carried out in particular in the presence of one or more suspending agents preferably chosen from organic suspending agents, such as poly(vinyl alcohol)s, hydroxyethylcellulose, methylcellulose, sodium dodecylbenzenesulphonate, starch, polyacrylamides or polyvinylpyrrolidones, in particular poly-N-vinylpyrrolidone, or from inorganic suspending agents, such as alumina, magnesium silicate, magnesium oxide, zinc oxide, tricalcium phosphate, barium phosphate, aluminium phosphate, magnesium pyrophosphate, calcium carbonate or calcium fluoride. The amount of suspending agent(s) can be from 0.05 to 5 parts, preferably from 0.1 to 4 parts, by weight per 100 parts by weight of styrene and optionally of comonomer or comonomers.

The polymerization can be carried out in the presence of other additives, such as chain-limiting agents, chosen in particular from mercaptans, such as n-dodecyl mercaptan, or the dimer of α-methylstyrene, flame retardants, chosen in particular from halogenated hydrocarbons, preferably brominated hydrocarbons, such as hexabromocyclohexane, pentabromomonochlorocyclohexane, hexabromocyclododecane, octabromobiphenyl, nonabromobiphenyl, decabromobiphenyl, octabromodiphenyl ether, nonabromodiphenyl ether or decabromodiphenyl ether, crosslinking agents, such as butadiene or divinylbenzene, and optionally nucleating agents, in particular organic nucleating agents, such as waxes, especially synthetic waxes, such as polyolefin waxes, especially polyethylene or polypropylene waxes.

The polymerization according to the invention is carried out in particular in the presence of 4 to 23 parts, preferably of 5 to 20 parts, in particular of 5 to 18 parts, of a blowing agent which is water or a mixture of water and at least one other blowing agent for example a particular hydrocarbon blowing agent, per 100 parts by weight of styrene and optionally of comonomer or comonomers. Generally, a portion of the blowing agent, in particular hydrocarbon blowing agent, employed during the polymerization is lost and is not reencountered in the expandable polystyrene composition. The hydrocarbon blowing agent is preferably chosen from saturated hydrocarbons, in particular linear or branched saturated hydrocarbons, and saturated cyclic hydrocarbons, in particular from saturated C₃ to C₇, more particularly C₄ to C₆, hydrocarbons. The hydrocarbon blowing agent can be a saturated hydrocarbon or a mixture of two or more saturated hydrocarbons chosen in particular from n-butane, isobutane, n-pentane, isopentane, n-hexane, isohexane, n-heptane and isoheptane, preferably a mixture of n-pentane and of isopentane. The blowing agent, in particular hydrocarbon blowing agent, can be introduced entirely at the beginning, during or at the end of polymerization, preferably at the beginning and/or during the polymerization, for example entirely at the beginning of polymerization, or else in two or more fractions distributed between the beginning and the end of the polymerization.

The polymerization is carried out in the presence of 0.1 to 12 parts, preferably of 0.2 to 10 parts, in particular of 0.3 to 8 parts, by weight of at least one modified clay with an at least partially lipophilic nature, as described above. Preference is given, among all the forms of clay described, to the use of a modified clay with an organic cation, such as an organic onium, phosphonium or sulphonium cation and more particularly a quaternary ammonium cation as defined in the general formula (1) having in particular four radicals chosen from alkyl, aryl, aralkyl and/or acyl radicals and preferably comprising at least one aralkyl radical, such as the benzyl radical. The organic cation which modifies the clay can advantageously have an organic radical itself having a carbon-carbon double bond, in particular a terminal carbon-carbon double bond, capable of reacting (or of (co)polymerizing) with the styrene employed during the polymerization and of thus forming a macromolecular styrene chain attached (or grafted) to the organic part of the cation. The modified clay with an at least partially lipophilic nature can thus change during the polymerization and can finally comprise an organic cation having an organic radical to which is attached (or grafted) a styrene polymer which is different in nature from or, preferably, identical in nature to the polymer of the composition. Thus, the modified clay, as employed in the polymerization, can advantageously comprise an organic cation having an organic radical with a carbon-carbon double bond, in particular a terminal carbon-carbon double bond, which can react (and in particular polymerize) with the styrene. The organic cation can be a quaternary ammonium cation chosen, for example, from vinylbenzyltrimethylammonium, vinylbenzyldimethyldodecylammonium and methacryloyloxy(2-ethylhexadecyl)dimethylammonium. The use of such a modified clay can advantageously result in an expandable polystyrene composition in the form of beads in which the structure of the clay is an “intercalated” lamellar structure or an “exfoliated” structure.

The at least partially lipophilic nature of the modified clay used in the polymerization can be as defined above. In particular, the modified clay can exhibit a substantially lipophilic nature.

The modified clay as used in the polymerization can be in the form of particles having a mean size ranging from 0.1 to 200 μm, preferably from 0.5 to 100 μm. It can in addition be provided in the form of particles having a length and a thickness in a length/thickness ratio ranging from 10/1 to 1000/1.

The modified clay can be introduced into the polymerization medium at the beginning of and/or during the polymerization, preferably before reaching a degree of conversion to polymer of 80%, in particular of 70%, especially of 60% and more particularly of 50%. It can very specifically be introduced before reaching the moment in the aqueous suspension polymerization known under the expression of “particle identity point” or PIP, which generally corresponds to the moment in the polymerization when the particles in suspension in the water reach a constant size which does not change further during the remainder of the polymerization.

By virtue of the modified clay as used in the aqueous suspension polymerization, the expandable polystyrene composition can comprise at least two blowing agents, one being water and the other being at least one hydrocarbon blowing agent. Depending on the clay used, its at least partially lipophilic nature and in particular its amphiphilic nature, it is possible to control as desired, during the aqueous suspension polymerization, the amount of water which the modified clay introduces into the expandable polystyrene composition, in particular as blowing agent. It is thus possible to adjust as desired the shares of water and of hydrocarbon blowing agent present in the beads of the expandable polystyrene composition and advantageously, for example, to increase the share of water and, in contrast, to reduce the share of hydrocarbon blowing agent.

Advantageously, the aqueous suspension polymerization can comprise a prestage of preparation (i) of an aqueous phase comprising water and the suspending agent(s), on the one hand, and (ii) of an organic phase comprising the styrene, optionally the comonomer(s), the radical polymerization initiator(s), the modified clay with an at least partially lipophilic nature and optionally a portion or all of the blowing agent(s),), on the other hand. In this prestage, the aqueous phase and the organic phase can advantageously be heated separately and at temperatures such that no substantial polymerization takes place in the aqueous phase and that subsequently, by mixing the two phases thus heated, an aqueous suspension is formed with stirring at a temperature equal to or greater than the temperature at which the polymerization spontaneously begins, for example at a temperature at least equal to 80° C., preferably at least equal to 85° C.

Another alternative form of the process for the preparation of the expandable polystyrene composition can comprise a stage of prepolymerization of the styrene and optionally of the comonomer(s) carried out under bulk or solution conditions. The stage of prepolymerization under bulk or solution conditions can be carried out by bringing the styrene and optionally the comonomer(s) into contact with the radical polymerization initiator(s), the modified clay with an at least partially lipophilic nature and optionally a portion or all of the blowing agent(s), and/or a solvent, in particular an aromatic solvent, such as ethylbenzene, at a temperature which can range from 80 to 150° C., preferably from 90 to 140° C., for a period of time in particular such that the degree of conversion to polymer does not exceed 80%, preferably 60%, in particular 50%. The prepolymer thus formed is subsequently brought into contact with stirring with an aqueous phase comprising water, the suspending agent(s), the styrene and optionally the comonomer(s) and/or the blowing agent(s), or the remaining portion of the blowing agent(s) not used in prepolymerization, so as to form an aqueous suspension and to continue the polymerization at a temperature which can range from 80 to 150° C., preferably from 90 to 140° C.

It has been found that the expandable polystyrene composition can be obtained in the form of beads and that no major difficulty, such as a “loss of suspension”, is encountered during its preparation. Such a result is probably related to the choice of the modified clay and of the blowing agent, in a preparation process which employs an aqueous suspension.

The present invention also relates to the use of the expandable polystyrene composition in the form of beads for manufacturing moulded and expanded objects having in particular a bulk density ranging from 5 to 50 kg/m³, preferably from 5 to 30 kg/m³. The beads are used in particular in a process successively comprising:

(i) a stage of preexpanding (or prefoaming) by mixing expandable polystyrene beads with and by bringing them into contact with steam, in particular in a stirred tank, in particular at a temperature ranging from 80 to 110° C., for example from 85 to 105° C., and under an absolute pressure which can range from 20 to 160 kPa, for example from 50 to 150 kPa, so as to form expanded beads having in particular a bulk density ranging from 5 to 50 kg/m³, preferably from 5 to 30 kg/m³,

(ii) a stage of stabilizing (or maturing) the beads thus expanded by bringing the latter into contact with the surrounding air, in particular at a temperature ranging from 0 to 40° C. and under an absolute pressure which can range from 50 to 130 kPa, preferably from 80 to 120 kPa, for a period of time which can range from a few hours to a few days, for example from 2 hours to 3 days, and

(iii) a stage of moulding the beads thus expanded and stabilized by introducing the latter into a mould and heating the mould, in particular at a temperature ranging from 80 to 120° C., so as to weld the beads together and to manufacture a moulded and expanded object having in particular a desired bulk density and especially one similar to that of the expanded beads obtained in stage (i).

It has been found, remarkably, that the manufacture of the moulded and expanded objects is not disrupted by the presence of modified clay with an at least partially lipophilic nature in the expandable polystyrene composition. In particular, during the stage of preexpanding with steam, expansion of the beads is not substantially affected and the presence of modified clay does not block the expansion of the beads. The expanded beads and the moulded and expanded objects thus obtained have a bulk density which can be as low as 5 kg/m³. The mean size of the cells in the expanded beads and the moulded and expanded objects can be relatively low and can range from 1 to 200 μm, preferably from 5 to 100 μm, with a relatively narrow distribution in the cell sizes. The moulded and expanded objects exhibit a noteworthy compromise in properties, such as good thermal insulation and high flame retardancy. They can advantageously be manufactured with a consistent quality, without random variation in the properties. Such results can probably be attributed to the choice of the modified clay used in the present composition.

The following examples illustrate the present invention.

In these examples the molecular weight of styrene polymer was determined by Gel Permeation chromatography (or SEC: Size-exclusion chromatography) using an Agilent HP 1100 apparatus. The apparatus was equipped with two 30 cm×8 mm KF-806M columns from Shodex, a guard column KF-G from Shodex and an UV detector (HP1100 Series G1365A, wavelength: 254 nm). The analyses were done under a uniform temperature 35° C. and with a flow rate of mL/min. A 3^{rd} order polynomial curve was used to define the calibration curve Log M=f(V) (V: elution volume) of the columns on the following molecular weight range: 7,100 000 g/mol to 162 g/mol (monodisperse PS standards). 100 μL samples injected for the analysis were taken from a 10 mL solution of tetrahydrofuran (THF)/Toluene (flow rate marker) containing 12.5±0.5 mg of dissolved EPS beads. The solution was filtered on a 0.45 μm PTFE filter before injection. The molecular weights given are relative values in comparison to the molecular weights of the following EPS standard: Mₙ=90 g/mol; M_{w}=210 g/L; M_{z}=400 g/mol.

### EXAMPLE 1

500 parts by weight of water and 0.225 part by weight of a poly(vinyl alcohol), sold under the commercial reference “PVA 224”® by Kuraray Co. Limited (Japan), are introduced, with stirring at ambient temperature (20° C.), into a reactor equipped with a stirring device and a jacket connected to a heating and cooling device, so as to obtain an aqueous mixture. A presuspension, prepared by mixing 300 parts by weight of styrene with 3 parts by weight of a modified clay with an at least partially lipophilic nature, sold under the commercial reference “Bentone 107”® by Elementis Specialities (USA), is prepared separately in a vessel, with stirring, for half an hour and at ambient temperature. The clay “Bentone 107”® is a bentonite essentially based on sodium montmorillonite modified by an ion-exchange treatment using a quaternary ammonium salt, in particular a dimethyldi(hydrogenated tallow alkyl)ammonium salt. The X-ray diffraction analysis of the clay “Bentone 107”®shows a diffraction peak at a 2θ angle of 3.36°, which corresponds to a lamellar structure having an interstitial distance of 2.6 nm. At the end of this time, 1.2 parts by weight of dibenzoyl peroxide and 0.54 part by weight of tert-butylperoxy 2-ethylhexyl carbonate are added to this presuspension with stirring and at ambient temperature, so as to obtain an organic suspension. The organic suspension is introduced, with stirring and at ambient temperature, into the reactor containing the aqueous mixture, so as to obtain a ready-for-use aqueous reaction suspension. The temperature of the reactor is then raised over 1 hour from 20° C. to 90° C. and it is maintained at 90° C. for 4.5 hours. At the end of this time, the temperature of the reactor is again raised over 1 hour from 90° C. to 120° C., while 24 parts by weight of a 75/25 mixture by weight of n-pentane and of isopentane respectively are introduced into the reactor. At the end of this time, the temperature of the reactor is maintained at 120° C. for 4 hours and then the reactor is cooled to ambient temperature. A suspension of expandable polystyrene beads is thus obtained. After separating from the aqueous phase, an expandable polystyrene composition in the form of beads is isolated which comprises 100 parts by weight of a polystyrene with a molecular weight Mw of 223 000 daltons and with a molecular weight distribution Mw/Mn of 2.4, 6.1 parts by weight of the mixture of n-pentane and of isopentane, 10.5 parts by weight of water (the moisture content of the beads being measured by the Karl-Fischer method) and 1 part by weight of modified clay with an at least partially lipophilic nature of “Bentone 107”® type.

The expandable beads are subjected to expansion by heating with steam under an absolute pressure of 128 kPa for 30 seconds to reach a density around 22 g/L, so that the beads thus expanded exhibit a similar structure comprising both large cells (110 μm±26 μm) and small cells (35 μm±10 μm).

### EXAMPLE 2

The preparation is carried out exactly as in Example 1, except that 1.5 parts by weight of “Bentone 107”® are used instead of 3 parts by weight.

An expandable polystyrene composition in the form of beads is thus obtained which is identical to that of Example 1, except that it comprises 0.5 part by weight of modified clay with an at least partially lipophilic nature of “Bentone 107”® type instead of 1 part by weight, and 1.3 parts by weight of water instead of 10.5 parts by weight. The analysis by X-ray diffraction of the clay present in the expandable beads shows the presence of a diffraction peak which has shifted from 3.36° (before polymerization) to 1.8° (after polymerization), which corresponds to a clay with an “intercalated” lamellar structure having an interstitial distance which has increased from 2.6 nm to 4.9 nm.

### EXAMPLE 3

The preparation is carried out exactly as in Example 2, except that the presuspension is prepared first by mixing, with stirring for 1 hour at ambient temperature (20° C.), 270 parts by weight of styrene with 30 parts by weight of a polystyrene in the form of granules, sold under the commercial reference “PS 152”® by BP Chemicals Limited (UK) with a weight-average molecular weight Mw of 250 000 daltons, and then by adding, to the mixture thus prepared, 1.5 parts by weight of the modified clay with an at least partially lipophilic nature “Bentone 107”®.

An expandable polystyrene composition in the form of beads is thus obtained which is identical to that of Example 2, except that it comprises 1.2 parts by weight of water instead of 1.3 parts by weight.

### EXAMPLE 4

The preparation is carried out exactly as in Example 1, except that, in place of “Bentone 107”®, use is made of a modified clay with an at least partially lipophilic nature sold under the commercial reference “Nanofil 2”® by Süd-Chemie (Germany). The clay of “Nanofil 2”® type is a bentonite essentially based on sodium montmorillonite modified by an ion-exchange treatment using a quaternary ammonium salt, in particular a dimethyl(hydrogenated tallow alkyl)benzylammonium salt. X-ray diffraction analysis reveals that the clay “Nanofil 2” exhibits a lamellar structure with an interstitial distance of 2 nm.

An expandable polystyrene composition in the form of beads is thus obtained which is identical to that of Example 1, except that it comprises 5.5 parts by weight of a mixture of n-pentane and of isopentane instead of 6.1 parts by weight, 13.8 parts by weight of water instead of 10.5 parts by weight, and 1 part by weight of modified clay with an at least partially lipophilic nature of “Nanofil 2”® type instead of the clay of “Bentone 107”® type. The analysis by X-ray diffraction of the clay present in the beads shows the absence of a peak, which corresponds to an exfoliated structure.

### EXAMPLE 5

500 parts by weight of water and 0.225 part by weight of a poly(vinyl alcohol), sold under the commercial reference “PVA 224”® by Kuraray Co. Limited, are introduced, with stirring at ambient temperature (20° C.), into a reactor equipped with a stirring device and a jacket connected to a heating and cooling device, so as to obtain an aqueous mixture. A mixture of 220 parts by weight of styrene, 1.2 parts by weight of dibenzoyl peroxide and 0.54 part by weight of tert-butylperoxy 2-ethylhexyl carbonate is prepared separately in a vessel, so as to obtain an organic mixture. The organic mixture is introduced, with stirring and at ambient temperature, into the reactor containing the aqueous mixture, so as to obtain a ready-for-use aqueous reaction suspension. The temperature of the reactor is then raised over 1 hour from 20° C. to 90° C. and it is maintained at 90° C. for 2 hours. At the end of this time, a presuspension, prepared beforehand by mixing 80 parts by weight of styrene with 3 parts by weight of “Bentone 107”®, is introduced, over 1 hour and at ambient temperature, with stirring into the reactor. After this introduction, the temperature of the reactor is maintained at 90° C. for a further 2 hours. At the end of this time, the temperature of the reactor is raised over 1 hour from 90° C. to 120° C., while 24 parts by weight of a 75/25 by weight mixture of n-pentane and of isopentane respectively are introduced into the reactor. At the end of this time, the temperature of the reactor is maintained at 120° C. for 4 hours and then the reactor is cooled to ambient temperature. A suspension of expandable polystyrene beads is thus obtained. After separating from the aqueous phase, an expandable polystyrene composition in the form of beads is isolated which comprises 100 parts by weight of a polystyrene having a weight Mw of 187 000 daltons and a molecular weight distribution Mw/Mn of 2.4, 6.4 parts by weight of a mixture of n-pentane and of isopentane, 1 part by weight of water and 1 part by weight of modified clay with an at least partially lipophilic nature of “Bentone 107”® type. The analysis by X-ray diffraction of the clay present in the expandable beads shows the presence of a diffraction peak at a 20 angle which has shifted from 3.36° (before polymerization) to 2.7° (after polymerization), which corresponds to a clay with an “intercalated” lamellar structure having an interstitial distance which has increased from 2.6 nm to 3.3 nm.

The expandable beads are subjected to expansion by heating with steam under an absolute pressure of 128 kPa for 1 minute 30 seconds, so that the beads thus expanded exhibit a bulk density of 29.6 g/l and a cellular structure comprising mainly small cells (approximately 17 μm±9 μm) with some large cells (bigger than 100 μm).

### EXAMPLE 6

The preparation is carried out exactly as in Example 5, except that the presuspension used is prepared with 1.5 parts by weight of a modified clay with an at least partially lipophilic nature, sold under the commercial reference “Nanofil 9”® by Süd-Chemie (Germany), instead of 3 parts by weight of “Bentone 107”®. The clay of “Nanofil 9”® type is a bentonite essentially based on sodium montmorillonite modified by an ion-exchange treatment using a quaternary ammonium salt, in particular a dimethyl(hydrogenated tallow alkyl)benzylammonium salt.

An expandable polystyrene composition in the form of beads is thus obtained which is identical to that of Example 5, except that it comprises 1.1 parts by weight of water instead of 1 part by weight, and 0.5 part by weight of modified clay with an at least partially lipophilic nature of “Nanofil 9” type instead of 1 part by weight of the clay of “Bentone 107”® type. The analysis by X-ray diffraction of the clay present in the expandable beads shows the absence of a peak, which corresponds to a clay with an “exfoliated” structure.

1-17. (canceled)

18. An expandable polystyrene composition in the form of beads, comprising:
(1) 100 parts by weight of a styrene polymer having in particular a weight-average molecular weight Mw ranging from 150 000 to 400 000 daltons,
(2) from 3 to 20 parts by weight of a blowing agent, which is water or a mixture of water with at least one other blowing agent for example a hydrocarbon,
(3) from 0.1 to 12 parts by weight of at least one modified clay with an at least partially lipophilic nature.

19. Composition according to claim 18, characterized in that the clay is chosen from phyllosilicates or lamellar silicates, optionally in the fibrous form.

20. Composition according to claim 18 or 19, characterized in that the clay is a cationic clay chosen in particular from a smectite, an illite, a chlorite and a hormite.

21. Composition according to claim 18, characterized in that the clay is a smectite chosen in particular from a montmorillonite, a nontronite, a beidellite, a hectorite, a saponite and a sauconite.

22. Composition according to claim 18, characterized in that the modified clay with an at least partially lipophilic nature is a clay modified by an ion-exchange treatment using an organic cation, in particular of an organic cationic surfactant.

23. Composition according to claim 18, characterized in that the modified clay comprises at least one organic cation chosen in particular from organic onium, phosphonium or sulphonium cations.

24. Composition according to claim 18, characterized in that the modified clay comprises at least one organic cation chosen in particular from primary, secondary, tertiary or, preferably, quaternary organic ammonium cations.

25. Composition according to claim 18, characterized in that the modified clay comprises at least one organic cation chosen from quaternary ammonium cations preferably having four radicals chosen from alkyl, aryl, aralkyl and/or acyl radicals and having in particular at least one aralkyl radical.

26. Composition according to claim 18, characterized in that the modified clay comprises at least one organic cation having an organic radical to which is attached a styrene polymer which is in particular different in nature from or, preferably, identical in nature to the polymer of the composition.

27. Composition according to claim 18, characterized in that the modified clay is present in the state uniformly dispersed in the expandable polystyrene composition.

28. Composition according to claim 18, characterized in that the modified clay is present in the expandable polystyrene composition in the form of an intercalated lamellar structure.

29. Composition according to claim 18, characterized in that the modified clay is present in the expandable polystyrene composition in the form of an exfoliated structure.

30. Composition according to claim 18, characterized in that it comprises from 3 to 20 parts by weight of at least two blowing agents, one being water and the other being at least one hydrocarbon blowing agent, in a water/hydrocarbon blowing agent(s) ratio by weight ranging from 0.1/1 to 10/1, preferably from 0.2/1 to 9/1, in particular from 0.5/1 to 8/1, especially from 1/1 to 7/1.

31. Process for the preparation of an expandable polystyrene composition in the form of beads, comprising a polymerization of styrene and optionally of at least one comonomer, carried out in aqueous suspension and with stirring, by bringing 100 parts by weight of styrene and optionally of the comonomer or comonomers into contact with at least one radical polymerization initiator and at least one suspending agent, which at least one radical polymerization initiator and at least one suspending agent which process is characterized in that the contacting operation is carried out in addition in the presence (a) of 4 to 23 parts by weight of a blowing agent which is water or a mixture of water and at least one other blowing agent for example a hydrocarbon blowing agent, and (b) of 0.5 to 12 parts by weight of at least one modified clay with an at least partially lipophilic nature.

32. Process according to claim 31, characterized in that it comprises a prestage of preparation (i) of an aqueous phase comprising water and the suspending agent(s), on the one hand, and (ii) of an organic phase comprising the styrene, optionally the comonomer(s), the radical polymerization initiator(s), the modified clay and optionally a portion or all of the blowing agent(s), on the other hand, the aqueous phase and the organic phase being heated separately and at temperatures such that no substantial polymerization takes place in the organic phase and that subsequently, by mixing the two phases thus heated, an aqueous suspension is formed with stirring at a temperature equal to or greater than the temperature at which the polymerization spontaneously begins, preferably at a temperature at least equal to 80° C., in particular at least equal to 85° C.

33. Process according to claim 31, characterized in that it comprises a stage of prepolymerization of the styrene and optionally of the comonomer(s), carried out under bulk or solution conditions, by bringing the styrene and optionally the comonomer(s) into contact with the radical polymerization initiator(s), the modified clay and optionally a portion or all of the blowing agent(s), and/or a solvent, the prepolymer thus formed subsequently being brought into contact with stirring with an aqueous phase comprising water, the suspending agent(s), the styrene and optionally the comonomer(s) and/or the blowing agent(s), or the remaining portion of the blowing agent(s) not used in prepolymerization, so as to form an aqueous suspension and to continue the polymerization.

34. Use of the expandable polystyrene composition in the form of beads as defined according to claim 18 or as prepared by the process according to any one of claim 31 to 33 for manufacturing moulded and expanded objects having in particular a bulky density ranging from 5 to 50 kg/m³, preferably from 5 to 30 kg/m³.
